(19) United States
(12) Patent Application Publication
(10) Pub. No.: US 2013/0201393 A1
(43) Pub. Date: Aug. 8, 2013

(54) DIGITAL CAMERA WITH TRANSLUCENT HOUSING

(71) Applicant: Christopher L. Hubbard, Honolulu, HI (US)

(72) Inventor: Christopher L. Hubbard, Honolulu, HI (US)

(73) Assignee: SONY CORPORATION

(21) Appl. No.: 13/367,872

(22) Filed: Feb. 7, 2012

(51) Int. Cl. H04N 5/225

(52) U.S. Cl. 348/376; 348/E05.026

(57) ABSTRACT

A camera includes a translucent or transparent housing having a color. The camera also includes a processor in the housing that is visible through the housing. The camera also includes a camera element in the housing that generates signals representing an image and that communicates with the processor. Additionally, the processor defines a periphery and the housing includes a visible border line positioned over at least a portion of the periphery to thereby highlight a presence of the processor.

### FIELD OF THE INVENTION

The present application relates generally to digital cameras with translucent or transparent housings.

### BACKGROUND OF THE INVENTION

Digital cameras in today's market are often visually indistinguishable from each other. For instance, cameras made by different manufactures may both have the same color and appearance. Hence, a need has arisen for a camera that is distinguishable from other cameras.

### SUMMARY OF THE INVENTION

Present principles recognize the advantages of providing a camera that has features that make it distinct from other cameras and that also provides aesthetic visual appeal. Accordingly, a camera includes a translucent or transparent housing having a color, the camera also having a processor in the housing. The processor is visible through the housing. The camera also includes a camera element in the housing that generates signals representing an image, it being understood that the processor communicates with the camera element. Additionally, the processor has a periphery and the housing has a visible border line positioned over at least a portion of the periphery of the processor to thereby highlight a presence of the processor.

Moreover, if desired, the border line may be a color matching the color of the housing. Also, in some embodiments, the color of the housing and/or border line may not be clear and the housing may be translucent.

In addition to the above, in some embodiments the camera may also include a wireless transceiver in the housing that communicates with the processor, as well as an audio player in the housing that communicates with the processor.

Also in some embodiments, the camera may include a removable memory device that is removably engageable with the housing. The removable memory device may have a color band matching the color of the housing. The camera may also include a flexible cord wearable by a person, the cord being wearable around a person's wrist or neck. The cord may be attached to the housing and may also have a color matching the color of the housing. If desired, the removable memory device may be attached to the cord such that the cord is attached to the housing by means of engaging the memory device with the housing.

In another aspect, in a translucent or transparent camera housing having a color and including at least one component of the camera that is visible through the housing, a method includes highlighting a presence of a processor in the housing. The method also includes highlighting one or both of a presence of a removable memory device that is removably engageable with the housing and a presence of a flexible cord wearable by a person. It is to be understood that the removable memory device is accessible by the processor. It is to be further understood that the cord is attached to the housing.

In still another aspect, a camera includes a translucent or transparent housing having a color. The camera also includes a camera element in the housing that generates signals representing an image. Furthermore, the camera has a processor in the housing that communicates with the camera element. At least one component of the camera is visible through the housing, and in some embodiments the visible component is the processor. In addition, the camera includes a removable memory device removably engageable with the housing and having a color band matching the color of the housing, and/or the camera includes a flexible cord wearable by a person and attached to the housing, the cord having a color matching the color of the housing.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example device according to present principles embodied as a digital camera, it being understood that present principles apply to other portable consumer electronics devices as well;

FIG. 2 is a perspective view of a digital camera with translucent or transparent housing, showing a border line positioned over a portion of the periphery of the processor to thereby highlight a presence of the processor and showing a removable memory medium with a color band matching the color of the housing;

FIG. 3 is a perspective view of a digital camera with translucent or transparent housing, showing a neck cord with glow color matching the color of the housing;

FIG. 4 is a perspective view of a digital camera with translucent or transparent housing, showing a wrist cord with glow color matching the color of the housing; and

FIG. 5 is a perspective view of a digital camera with translucent or transparent housing with a telescoping lens piece.

### DETAILED DESCRIPTION OF THE PREFERRED EMBODIMENT

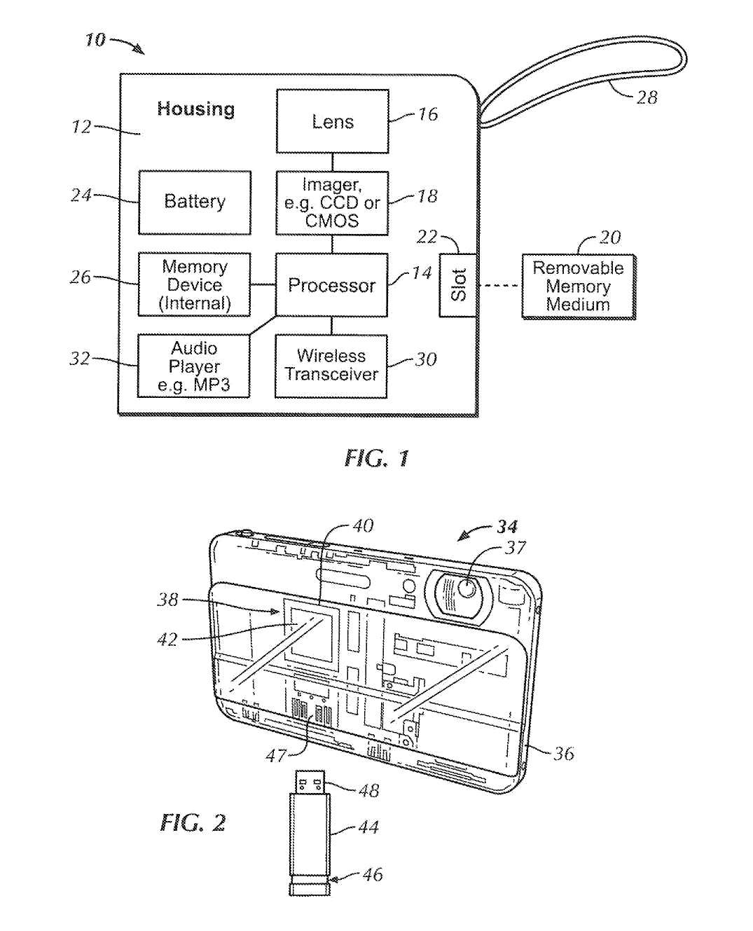

Beginning initially with FIG. 1, a block diagram of an example device according to present principles embodied as a digital camera is shown. However, note that present principles apply to other portable consumer electronics devices such as, but not limited to, laptop computers, tablet computers, smartphones, video game consoles, televisions, DVD players, audio, players, GPS units, etc. Thus, FIG. 1 shows a camera 10 that includes a housing 12. The housing 12 is translucent or transparent and has a color. The color of the housing 12 may be clear or it may be any other color including any neon color like neon yellow or hot pink.

The camera 10 also includes a processor 14 that may be a Sony Bionz processor in non-limiting embodiments. The processor 14 is understood to be visible through the housing at least in part because of the translucent or transparent housing 12. It is to be understood that the processor 14 defines a periphery. Though not shown in FIG. 1, it is to also be understood that the housing 12 has a visible border line positioned over at least a portion of the periphery of the processor 14 to thereby highlight a presence of the processor 14. The border line may have a color matching the color of the housing 12, or it may have a different color. The borderline may be formed on the housing 12 itself, around the processor within the housing 12, between the housing 12 and processor 14 to provide the appearance that the border line is hovering over the processor 14, or any other suitable means for positioning the border line over at least a portion of the periphery to highlight a presence of the processor 14.

Moreover, in some embodiments the border line is at least partially defined by and/or includes neon accents and/or other lighting such as light-emitting diodes (LEDs) to give the visual appearance that the periphery of the processor 14 is glowing. It is to be understood that the neon accents and/or LEDs may generally be the same color as the rest of the housing 12, though in some embodiments they may be a different color and/or include plural colors at one time. However, in addition to or alternatively to the neon accents and/or LEDs, the border line may include other lighting and/or may include reflective material to highlight a presence of the processor. Though the discussion regarding the border line set forth above has been directed toward highlighting a presence of the processor, it is to be understood that present principles may apply to highlighting a presence of any component of a digital camera, including the components referenced below.

Thus, still in reference to FIG. 1, the camera 10 also includes a lens 16 and an imager 18 such as, but not limited to, charge coupled device (CCD) or complementary metal oxide semiconductor (CMOS). Regardless of the type of imager, the imager 18 receives light through the lens 16 and generates signals representing an image. Also, note that the processor 14 communicates with the imager 18.

In addition to the foregoing, the camera 10 may also include a removable memory device/medium 20 that is removably engageable with the housing 12 and may store images, video, sound, etc. that is taken by the camera 10, as well as music to be played through an audio player which will be described further below. The removable memory medium may be a “thumb drive, ” “flash drive,” USB drive, etc. The removable memory medium 20 may also have a color band including neon accents and/or LEDs matching the color of the housing and may be translucent or transparent to further match the housing 12. Regardless of the color, the removable memory medium 20 may be engaged with the camera 10 via a slot 22. Once engaged, the removable memory medium 20 is able to communicate with the processor 14. When engaged with the camera 10, the camera 10 may supply power from a battery 24 to activate the neon accents and/or LEDs on the removable memory medium 20 to provide the visual appearance that at least part of the removable memory medium 20 is glowing, it being understood that the battery 24 also provides power to other parts of the camera 10 such as the imager 18 and processor 14. Additionally, note that the camera 10 may have an internal memory device 26 that communicates with the processor 14.

In addition to the removable memory medium 20, the camera 10 may also be engageable with a flexible cord 28 wearable by a person and attached to the housing 12. The cord may have a color matching the color of the housing, and may also be translucent or transparent to further match the housing 12. The cord 28 may also have neon accents and/or LEDs that may be powered by the battery 24 when the cord 28 is engaged with the housing 12. In lieu of or in addition to the neon accents and/or LEDs, the cord 28 may also provide light through chemoluminescence. Either way, present principles recognize that the cord 28 may have the visual appearance of glowing.

FIG. 1 also shows that the camera 10 includes a wireless transceiver 30 in the housing 12 that communicates with the processor 14 and is able to connect to the Internet and/or a Wi-Fi network to, e.g., allow the camera 10 to download music to be played through an audio player 32 in the housing 12 included in some embodiments. It is therefore to be understood that the audio player 32 communicates with the processor 14. If desired, the audio player 32 may be an MP3 player and the camera 10 may have a port to receive a headphone connector element from audio headphones to thereby output sound through the headphones. Though not shown, the headphones may also be translucent or transparent, the same color as the housing 12, and/or have at least one neon accent/LED in accordance with present principles. Also in some embodiments, the transceiver 30 and audio player 32 may be visible through the housing 12 and may have respective border lines similar to the border line described above. Furthermore, note that any or all of the components of the camera 10 may be visible through the housing 12 in non-limiting embodiments, and may each have respective border lines as indicated above.

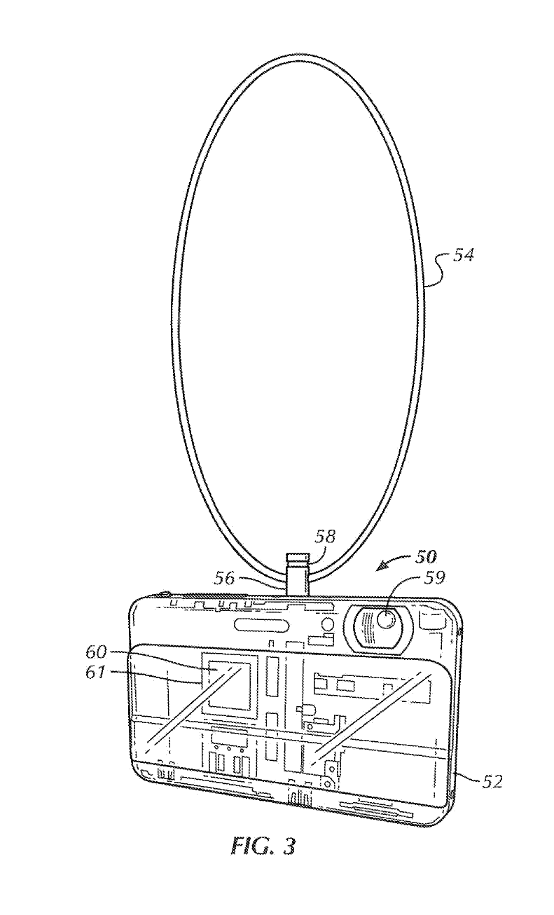

Moving on, FIG. 2 shows a perspective view of a camera substantially similar in function and configuration to the camera 10 described above. FIG. 2 shows a translucent or transparent housing 36 of a camera 34. It may be appreciated from FIG. 2 that a border line 38 is positioned over a portion of a periphery 40 of a processor 42 in the camera 34 to thereby highlight a presence of a processor 42. It may also be appreciated from FIG. 2 that various components of the camera 34 are visible through the housing 36, including the processor 42 and a lens 37.

Additionally, FIG. 2 shows a removable memory medium 44 substantially similar to the medium 20 described above. Thus, the removable memory medium 44 may have a color band 46 matching the color of the housing 36. As may be appreciated from FIG. 2, the removable memory medium 44 has at least one color band 46 that may generally be the same color as the rest of the removable memory medium 44. Moreover, it is to be understood that in the exemplary embodiment shown, the band 46 may the at least partially defined by and/or include at least one neon accent and/or LEDs to thereby provide the appearance that the band 46 and medium 44 are glowing. The lighting on the band 46 may be activated when the removable memory medium 44 is engaged with the camera 34, though the band 46 may be activated regardless of whether it is engaged with the camera 34 in some embodiments. However, when engaged with the camera 34, the band 46 may be positioned at an end of the removable memory medium 44 opposite the end that is engaged with the camera 34 via a slot 47 in the bottom of the camera. In some embodiments, the slot 47 may be a USB port that receives, e.g., a USB connector 48 on the removable memory medium 44.

Turning now to FIG. 3, a perspective view of a digital camera 50 substantially similar in function and configuration to the cameras described above is shown. The camera 50 has a translucent or transparent housing 52 making a processor 60 visible therethrough, it being understood that the processor 60 has a periphery 61 and may have border lines in accordance with present principles (though not shown in FIG. 3 for clarity). Thus, the camera 50 may have a color and neon accents/LEDs similar to the cameras described above. A neck cord 54 is shown in FIG. 3, it being understood that the cord 54 of the present exemplary embodiment is suitable for being positioned around a person's neck. Furthermore, the cord 54 may have a color matching the color of the housing 52. Similar to the cord 28 described above, the cord 54 includes a neon accent(s) and/or LEDs along all or part of the cord 54, thereby giving the appearance that the cord 54 is glowing when the neon accent(s) and/or LEDs are activated. The neon accent(s) and/or LEDs in the cord 54 may have their own power source independent of a battery (not shown), or may receive power from a battery in the camera 50 when the cord 54 is engaged with the camera 10.

In the exemplary embodiment shown in FIG. 3, the cord 54 may be engaged with the camera 50 by way of the removable memory medium 56 rather than being directly engaged with the housing 52. The cord 54 is thus attached to the removable memory medium 56 such that the cord 54 is attached to the top of the housing 52 by means of engaging the removable memory medium 56 with the housing 52. As may be appreciated from FIG. 3, the removable memory medium 56 is engaged with a slot (not shown) in top of the camera 50 and locks in place when engaged to support the weight of the camera without damaging the medium 56 or causing it to be unintentionally dislodged from the camera 50.

Additionally, note that the removable memory medium 56 has at least one color band 58 substantially similar in function and configuration to the band 46 described above, including that the band 58 may be the same color as the housing 52 and/or rest of the removable memory medium 56, and includes neon accents and/or LEDs to illuminate the band 58. Furthermore, a lens 59 may also be visible through the housing 52 in accordance with present principles.

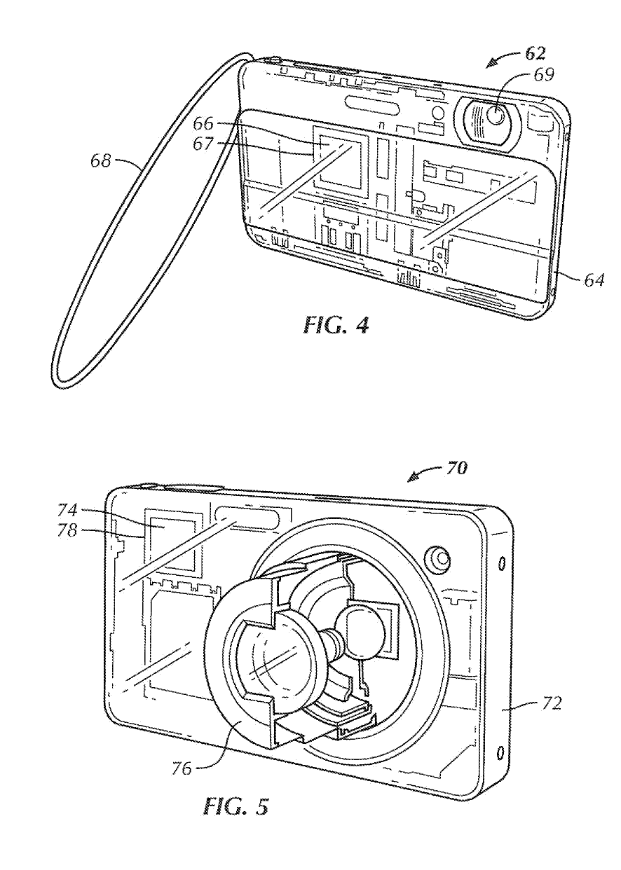

Now in reference to FIG. 4, a perspective view of a digital camera 62 substantially similar in function and configuration to the cameras described above is shown. The camera 62 includes with translucent or transparent housing 64 making an internal camera component such as a processor 66 having a periphery 67 visible therethrough. Note that the camera 62 may have a color and neon accents/LEDs similar to the cameras described above. FIG. 4 also shows a wrist cord 68 substantially similar in function and configuration to the cord 54 described above save the fact that the cord 68 is more suitable for being worn around a person's wrist rather than a person's neck and is directly engaged with the housing 64 rather than being engaged with a removable memory medium that is then engaged with the camera 62. Accordingly, the cord 68 may have a glow color matching the color of the housing 64. Also note that a lens 69 may be visible through the housing 52 in accordance with present principles

Concluding the detailed description with reference to FIG. 5, a perspective view of a digital camera 70 substantially similar in function and configuration to the cameras described above is shown. Thus, the camera 70 includes a translucent or transparent housing 72 making an internal camera component such as a processor 74 visible therethrough and having a periphery 78. Note that the camera 70 may have a color and neon accents/LEDs similar to the cameras described above. The camera 70 of FIG. 5 further includes a telescoping lens piece 76 which may also be translucent or transparent and have a color matching the color of the rest of the camera 70 and neon accents/LEDs (not shown). Thus, individual components of the lens piece 76 may be visible such as a camera lens that may be glass and/or any wiring therein.

It may now be appreciated from the principles set forth herein that camera may have a translucent or transparent housing having a color. The housing thereby allows at least one component of the camera to be visible through the housing. The presence of one or more of these visible components (such as the camera's processor) may be highlighted by neon accents and/or LEDs. Furthermore, the presence of a removable memory device removably engageable with the housing and accessible by the processor may be highlighted by neon accents and/or LEDs, and the presence of a flexible cord wearable by a person and attached to the housing may be similarly highlighted.

While the particular DIGITAL CAMERA WITH TRANSLUCENT HOUSING is herein shown and described in detail, it is to be understood that the subject matter which is encompassed by the present invention is limited only by the claims.

What is claimed is:

1. A camera, comprising:
a translucent or transparent housing having a color;
a processor in the housing and visible through the housing, the processor defining a periphery; and
a camera element in the housing and generating signals representing an image, the processor communicating with the camera element, wherein
the housing further comprises a visible border line positioned over at least a portion of the periphery of the processor to thereby highlight a presence of the processor.

2. The camera of claim 1, wherein the border line has a color matching the color of the housing.

3. The camera of claim 1, wherein the color is not clear and the housing is translucent.

4. The camera of claim 1, further comprising a wireless transceiver in the housing and communicating with the processor.

5. The camera of claim 1, further comprising an audio player in the housing and communicating with the processor.

6. The camera of claim 1, further comprising a removable memory device removably engageable with the housing and having a color band matching the color of the housing.

7. The camera of claim 1, further comprising a flexible cord wearable by a person and attached to the housing, the cord having a color matching the color of the housing.

8. The camera of claim 7, further comprising a removable memory device removably engageable with the housing and having a color band matching the color of the housing, the removable memory device being attached to the cord such that the cord is attached to the housing by means of engaging the memory device with the housing.

9. In a translucent or transparent camera housing having a color and including at least one component of the camera that is visible through the housing, a method comprising:
highlighting a presence of a processor in the housing; and
highlighting one or both of the following:
a presence of a removable memory device removably engageable with the housing and that is accessible by the processor and/or a presence of a flexible cord wearable by a person and attached to the housing.

10. The method of claim 9, wherein the removable memory device has a color band matching the color of the housing and the cord has a color matching the color of the housing.

11. The method of claim 9, wherein the housing further includes a camera element generating signals representing an image, the processor communicating with the camera element.

12. The method of claim 9, wherein the processor is visible through the housing.

13. The method of claim 9, wherein the housing further includes a visible border line positioned to cover at least a portion of a periphery of the processor to thereby highlight a presence of the processor.

14. The method of claim 14, wherein the border line has a color matching the color of the housing.

15. The method of claim 9, wherein the color is not clear and the housing is translucent.

16. The method of claim 9, further comprising a wireless transceiver in the housing and communicating with the processor.

17. The method of claim 9, further comprising an audio player in the housing and communicating with the processor.

18. A camera, comprising:
a translucent or transparent housing having a color;
a camera element in the housing generating signals representing an image, a processor in the housing communicating with the camera element; wherein
at least one component of the camera is visible through the housing; and
wherein the camera includes a removable memory device removably engageable with the housing and having a color band including neon accents matching the color of the housing and/or the camera includes a translucent or transparent flexible cord wearable by a person and attached to the housing, the cord having neon accents matching the color of the housing.

19. The camera of claim 18, wherein the housing further comprises a visible border line positioned to cover at least a portion of a periphery of the processor to thereby highlight a presence of the processor.

20. The camera of claim 19, wherein the border line has a color matching the color of the housing.
